(19) United States
(12) Patent Application Publication
(10) Pub. No.: US 2010/0310136 A1
(43) Pub. Date: Dec. 9, 2010

(54) DISTINGUISHING RIGHT-HAND INPUT AND LEFT-HAND INPUT BASED ON FINGER RECOGNITION

(75) Inventor: Takamoto Tsuda, Malmo (SE)

Correspondence Address: SNYDER, CLARK, LESCH & CHUNG, LLP, 950 Herndon Parkway, Suite 365, HERNDON, VA, 20170, US

(73) Assignee: SONY ERICSSON MOBILE COMMUNICATIONS AB, Lund (SE)

(21) Appl. No.: 12/481,067

(22) Filed: Jun. 9, 2009

(51) Int. Cl. G06K 9/00; G06F 3/041

(52) U.S. Cl. 382/124; 345/173

(57) ABSTRACT

A device may include a first sensor for detecting a finger and a second sensor for capturing an image of the finger. In addition, the device may include a processor to obtain an image from the second sensor when the first sensor detects a finger, determine whether the detected finger belongs to a right hand or a left hand based on the image, perform a function associated with the right hand when the detected finger belongs to the right hand, and perform a function associated with the left hand when the detected finger belongs to the left hand.

### BACKGROUND

In many types of devices, a user may provide input via a touch screen. The touch screen allows the user to interact with graphical user interface (GUI) objects that are shown on the screen display.

### SUMMARY

According to one aspect, a device may include a first sensor for detecting a finger and a second sensor for capturing an image of the finger. Additionally, the device may include a processor to obtain an image from the second sensor when the first sensor detects a finger, determine whether the detected finger belongs to a right hand or a left hand based on the image, perform a function associated with the right hand when the detected finger belongs to the right hand, and perform a function associated with the left hand when the detected finger belongs to the left hand.

Additionally, when the processor performs a function associated with the right hand, the processor may be further configured to arrange graphical user interface (GUI) components for the right hand.

Additionally, the graphical user interface (GUI) components may include at least one of a button, a menu item, an icon, a cursor, an arrow, a text box, a scroll bar, an image, text, or a hyperlink.

Additionally, the processor may be further configured to register the right hand and the left hand.

Additionally, the processor to register the right hand is further configured to associate a registration image of the finger with the right hand.

Additionally, the device may include a mobile phone, an electronic notepad, a gaming console, a laptop computer, a personal digital assistant, or a personal computer.

Additionally, the first sensor may include a touch screen; and the second sensor may include one of a scanner, a charge coupled device, an infrared sensor, or an acoustic sensor.

Additionally, the image may include at least one of image of veins of the finger, a fingerprint, or finger shape.

Additionally, the second sensor may be located in an action button area included within the display.

Additionally, the function may include at least one of browsing a web page, placing a call, sending an email to a particular address, sending multimedia message, sending an instant message, viewing or editing a document, playing music or video, scheduling an event, or modifying an address book.

According to another aspect, a method may include detecting a finger when the finger is close to or touching a display of a device, obtaining an image of the finger when the finger is detected, determining whether the finger belongs to a right hand or a left hand based on the image, providing a left-hand graphical user interface when the finger belongs to the left hand, and providing a right-hand graphical user interface when the finger belongs to the right hand.

Additionally, responding to user input may include one or more of loading a web page, placing a call to a particular user, opening an email application to compose an email to be sent to a particular address, sending a multimedia message to a user, sending an instant message to one or more users, loading a document for editing, playing music or video; scheduling an appointment, or inserting or deleting an entry from an address book.

Additionally, the method may further include registering the right hand and the left hand.

Additionally, registering the right hand may include capturing a registration image of the finger, creating an association between the registration image and the right hand, and storing the association between the registration image and the right hand.

Additionally, the method may further include authenticating a user based on the image.

Additionally, obtaining the image of the finger may include obtaining an image of veins of the finger, obtaining a fingerprint, or obtaining a shape of the finger.

Additionally, obtaining an image may include obtaining the image based on at least one of: reflected light from the finger, a reflected infrared signal, or a reflected acoustic signal.

According to yet another aspect, a computer-readable medium including computer-executable instructions, the computer-executable instructions including instructions for obtaining an image of a finger from a sensor when a device detects a touch, retrieving identification information by looking up the identification information in a database based on the image, identifying a hand to which the finger belongs based on the identification information, and displaying a graphical user interface that is associated with the identified hand.

Additionally, the device may include one of a cell phone, an electronic notepad, a gaming console, a laptop computer, a personal digital assistant, or a personal computer.

Additionally, the computer-readable medium further include instructions for associating a registration image of the finger with the identified hand.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 illustrates the concepts described herein;

FIG. 2 is a diagram of an exemplary device that implements the concepts described herein;

FIG. 3 is a block diagram of the device of FIG. 2;

FIG. 4 is a diagram of exemplary components of an exemplary display screen of the device of FIG. 2;

FIG. 5 is a block diagram of exemplary functional components of the device of FIG. 2;

FIGS. 6A and 6B illustrate exemplary graphical user interface (GUI) components for receiving input from a left hand and right hand;

FIG. 7 is a flow diagram of an exemplary process associated with hand registration;

FIG. 8 is a flow diagram of an exemplary process for identifying/recognizing a hand; and

FIG. 9 illustrates an example associated with identifying/recognizing a hand.

### DETAILED DESCRIPTION

The following detailed description refers to the accompanying drawings. The same reference numbers in different drawings may identify the same or similar elements. As used herein, the term “veins” may refer to blood vessels (e.g., capillaries, veins, etc.). In addition, the term “right-hand graphical user interface (GUI) objects” may refer to GUI objects that are designed for interaction with a user's right hand. Similarly, the term “left-hand GUI objects” may refer to GUI objects that are designed for interaction with the user's left hand.

In the following, a device may identify one or more user's fingers that provide input to the device (e.g., a thumb of the right hand, an index finger of the left hand, etc.). Based on the identification, the device may authenticate the user and/or provide specific functionalities that are adapted for right-hand or left-hand input.

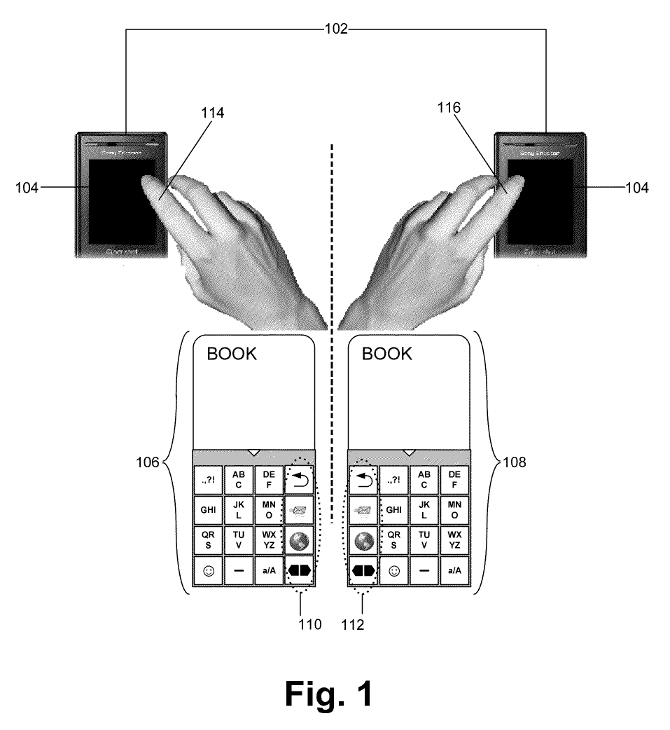

FIG. 1 illustrates one implementation of the above concept. FIG. 1 shows a device 102 that is capable of recognizing/identifying fingers for authentication and/or GUI interaction. Device 102 may include a touch screen 104, which, in turn, may display right-hand GUI objects 106 or left-hand GUI objects 108. Although GUI objects 106 and 108 may include different types of buttons, menu items, icons, cursors, arrows, textboxes, images, text, selectable list box, hyperlinks, etc., GUI objects 106 and 108 in FIG. 1 are illustrated as windows with GUI alpha-numeric keypads.

As further shown in FIG. 1, GUI objects 106 and 108 may include short-cut buttons 110 and 112, respectively. Short-cut buttons 110 may be arranged within GUI object 106 to allow a user to more conveniently access short-cut buttons 110 with the user's right hand than with the left hand. For example, short-cut buttons 110 may be located at the right side of touch screen 104, such that touching one of short-cut buttons 110 with the right hand does not substantially interfere with the user's view of GUI objects 106. Similarly, short-cut buttons 112 may be arranged within GUI object 108 to allow the user to more conveniently access short-cut buttons 112 with the user's left hand than with the right hand.

In the above, when a finger 114 of the user's right hand approaches touch screen 104, device 102 may sense and identify finger 114 based on an image of finger 114 (e.g., fingerprint, shape, image of veins of finger 104, etc.). For example, device 102 may match the image of finger 114's veins to a database of images of veins associated with those of authorized users of device 102.

Upon identifying finger 114, device 102 may authenticate the user whom finger 114 belongs to, determine whether finger 114 belongs to the right hand or the left hand, and/or display right-hand or left-hand GUI objects. For example, in FIG. 1, device 102 may recognize that finger 114 belongs to Mr. Takamoto's right hand, authenticate Mr. Takamoto, and display GUI objects 106 for interaction with the right hand. Similarly, when finger 116 approaches touch screen 104, device 102 may recognize that finger 116 belongs to Mr. Takamoto's left hand, authenticate Mr. Takamoto, and display GUI objects 108 for interaction with the left hand. By selectively enabling either right-hand or left-hand GUI objects 106 or 108, device 102 may provide the user with increased convenience.

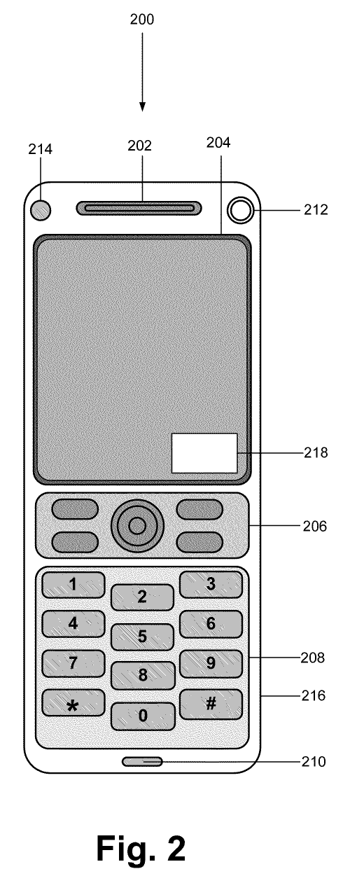

FIG. 2 is a diagram of an exemplary device 200 in which the concepts described herein may be implemented. Device 200 may include any of the following devices: a mobile telephone; a cellular phone; a personal communications system (PCS) terminal that may combine a cellular radiotelephone with data processing, facsimile, and/or data communications capabilities; an electronic notepad, a laptop, and/or a personal computer; a personal digital assistant (PDA) that can include a telephone; a gaming device or console; a peripheral (e.g., wireless headphone); a digital camera; or another type of computational or communication device that combines a touch screen capable of obtaining an image of finger (e.g., image of veins of the finger, finger shape, fingerprint, etc.).

In this implementation, device 200 may take the form of a mobile phone (e.g., a cell phone). As shown in FIG. 2, device 200 may include a speaker 202, a display 204, control buttons 206, a keypad 208, a microphone 210, sensors 212, a front camera 214, and a housing 216. Speaker 202 may provide audible information to a user of device 200.

Display 204 may provide visual information to the user, such as an image of a caller, video images, or pictures. In addition, display 204 may include a touch screen for providing input to device 200. Furthermore, display 204 may be capable of obtaining one or more images of a finger that is proximate to the surface of display 204.

In some implementations, instead of whole display 204 being capable of obtaining the images of a finger, display 204 may include one or more action button areas 218 in which display 204 can obtain an image of a finger. Display 204 may provide hardware/software to detect the image (e.g., image of veins of the finger) in action button area 218. In different implementations, action button area 218 may be located in a different screen area, be smaller, be larger, and/or have a different shape (e.g., circular, elliptical, square, etc.) than that illustrated in FIG. 2.

Control buttons 206 may permit the user to interact with device 200 to cause device 200 to perform one or more operations, such as place or receive a telephone call. Keypad 208 may include a telephone keypad. Microphone 210 may receive audible information from the user. Sensors 212 may collect and provide, to device 200, information (e.g., acoustic, infrared, etc.) that is used to aid the user in capturing images or in providing other types of information (e.g., a distance between a user and device 200). Front camera 214 may enable a user to view, capture and store images (e.g., pictures, video clips) of a subject in front of device 200. Housing 216 may provide a casing for components of device 200 and may protect the components from outside elements.

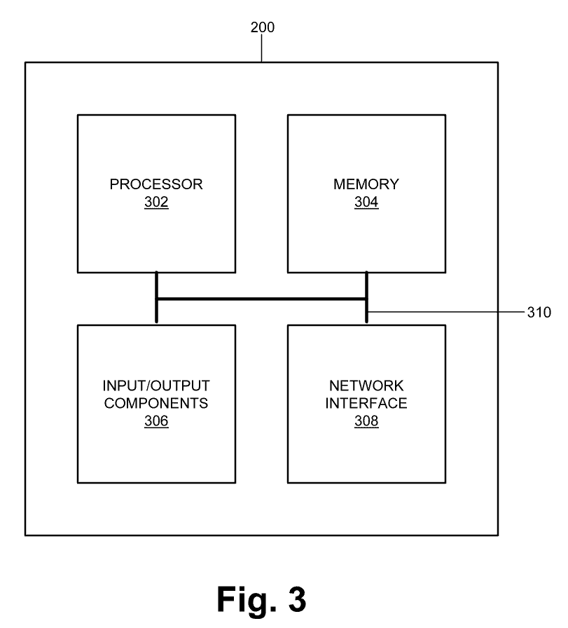

FIG. 3 is a block diagram of the device of FIG. 2. As shown in FIG. 3, device 200 may include a processor 302, a memory 304, input/output components 306, a network interface 308, and a communication path 310. In different implementations, device 200 may include additional, fewer, or different components than the ones illustrated in FIG. 2. For example, device 200 may include additional network interfaces, such as interfaces for receiving and sending data packets.

Processor 302 may include a processor, a microprocessor, an Application Specific Integrated Circuit (ASIC), a Field Programmable Gate Array (FPGA), and/or other processing logic (e.g., audio/video processor) capable of processing information and/or controlling device 200. Memory 304 may include static memory, such as read only memory (ROM), and/or dynamic memory, such as random access memory (RAM), or onboard cache, for storing data and machine-readable instructions. Memory 304 may also include storage devices, such as a floppy disk, CD ROM, CD read/write (R/W) disc, and/or flash memory, as well as other types of storage devices.

Input/output components 306 may include a display screen (e.g., display 106, display 204, etc.), a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to device 200.

Network interface 308 may include any transceiver-like mechanism that enables device 200 to communicate with other devices and/or systems. For example, network interface 308 may include mechanisms for communicating via a network, such as the Internet, a terrestrial wireless network (e.g., a WLAN), a cellular network, a satellite-based network, a WPAN, etc. Additionally or alternatively, network interface 308 may include a modem, an Ethernet interface to a LAN, and/or an interface/ connection for connecting device 200 to other devices (e.g., a Bluetooth interface).

Communication path 310 may provide an interface through which components of device 200 can communicate with one another.

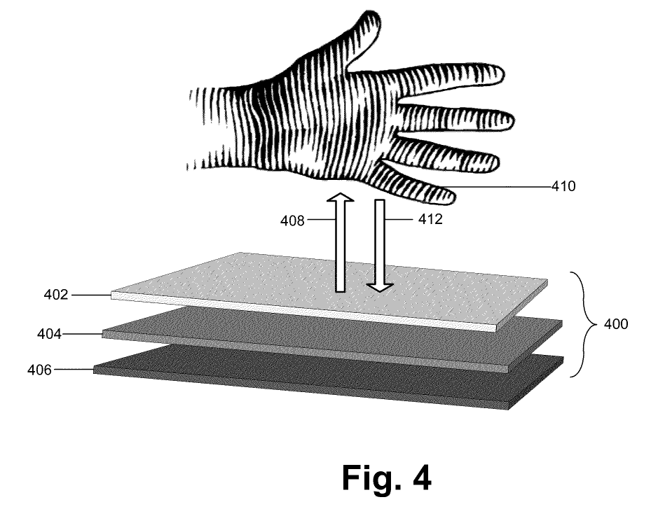

FIG. 4 is a diagram of exemplary components of a display screen 400 of device 200. As shown, display screen 400 may include a touch panel 402, display panel 404, and scanning panel 406. Depending on the implementation, display screen 400 may include additional, fewer, or different components than those illustrated in FIG. 4 (e.g., additional panels, screens, etc.).

Touch panel 402 may include a transparent panel/surface for locating the position of a finger or an object (e.g., stylus) when the finger/object is touching or is close to touch panel 402. Touch panel 402 may overlay display panel 404, but still allow images on display panel 404 to be viewed. In addition, touch panel 402 may allow external light to impinge on scanning panel 406. In one implementation, touch panel 404 may generate an electric field at its surface and detect changes in capacitance and the electric field due to a nearby object. A separate processing unit (not shown) that is attached to an output of touch panel 402 may use the output of touch panel 402 to generate the location of disturbances in the electric field, and thus the location of the object.

Display panel 404 may include a liquid crystal display (LCD), organic light-emitting diode (OLED) display, and/or another type of display that is capable of providing images to a viewer. In some implementations, display panel 404 may permit light (e.g., infrared) to pass through its surface to scanning panel 408.

Scanning panel 406 may include components to capture an image of a finger (e.g., finger's shape, fingerprint, an image of veins of the finger) that is close to the surface of display screen 400. In one implementation, scanning panel 406 may include arrays of charge-coupled devices (CCDs) configured to capture the image. In another implementation, scanning panel 406 may include a source of light that may emanate from scanning panel 406 and pass through display panel 404 and touch panel 402 in the direction of arrow 408. When light that is reflected from a finger 410 arrives at scanning panel 406 through touch panel 402 and display panel 404, scanning panel 406 may capture an image of finger 412. In still another implementation, scanning panel 406 may emit acoustic waves to a finger that touches the surface of touch panel 402 and obtain the image of finger 412 based on reflected waves.

In some implementations, in place of scanning panel 406, display screen 400 may include a specialized hardware component that is limited to an area, such as action button area 218 in display 204, for obtaining images of a finger. In still other implementations, touch panel 402 and/or display panel 404 may include integrated, specialized area(s) that either spans the whole surface area of display screen 400 or a limited area(s) (e.g., one or more of action button area 218), for obtaining the images.

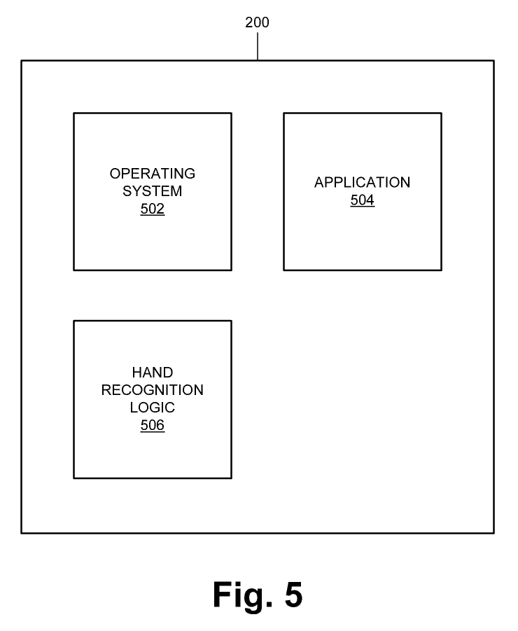

FIG. 5 is a block diagram illustrating exemplary functional components of device 200. As shown, device 200 may include an operating system 502, application 504, and hand recognition logic 506. Operating system 502 may manage hardware and software resources of device 200. Operating system 302 may manage, for example, a file system, device drivers, communication resources (e.g., transmission control protocol (TCP)/IP stack), event notifications, etc. Application 504 (e.g., an email client, web browser, instant messenger, media player, phone, address book, word processor, etc.) may include software components for performing a specific set of tasks (e.g., sending an email, providing sound upon receiving a call, scheduling an appointment for a meeting, browsing a web page, etc.).

In one exemplary embodiment, hand recognition logic 506 may include hardware and/or software components for obtaining an image of a finger and identifying a specific finger by matching the image against a database of finger images. Based on the identification, hand recognition logic 506 may determine whether the finger belongs to a right hand or a left hand of the user. In some implementations, based on the identification, hand recognition logic 506 may also authenticate the user.

In addition, hand recognition logic 506 may allow a user to register one or more images of fingers of the user and associate each of the images with an identifier (e.g., “right thumb,” “left index finger,” etc.), right hand, left hand, and/or user. Hand recognition logic 506 may provide a GUI to register the images, and may store the images in a database (e.g., in memory 304). Once the registration is complete, application 504 and/or hand recognition logic 506 may allow the user to associate the registered images with a short cut and/or particular tasks of application 504/hand recognition logic 506.

Depending on the implementation, device 200 may include fewer, additional, or different functional components than those illustrated in FIG. 5. For example, in one implementation, device 200 may include additional applications, databases, etc. In addition, one or more functional components of device 200 may provide the functionalities of other components. For example, in a different implementation, operating system 502 and/or application 504 may provide the functionalities of hand recognition logic 506. In such an implementation, device 200 may or may not include hand recognition logic 506. In another implementation, application 504 may use hand recognition logic 506 to perform a task. For example, assume that application 504 is a word processor. When a user's hand approaches the display screen of device 200, application 504 may use hand recognition logic 506 to identify the hand, and enable selected menu components (e.g., edit, view, tools, etc.).

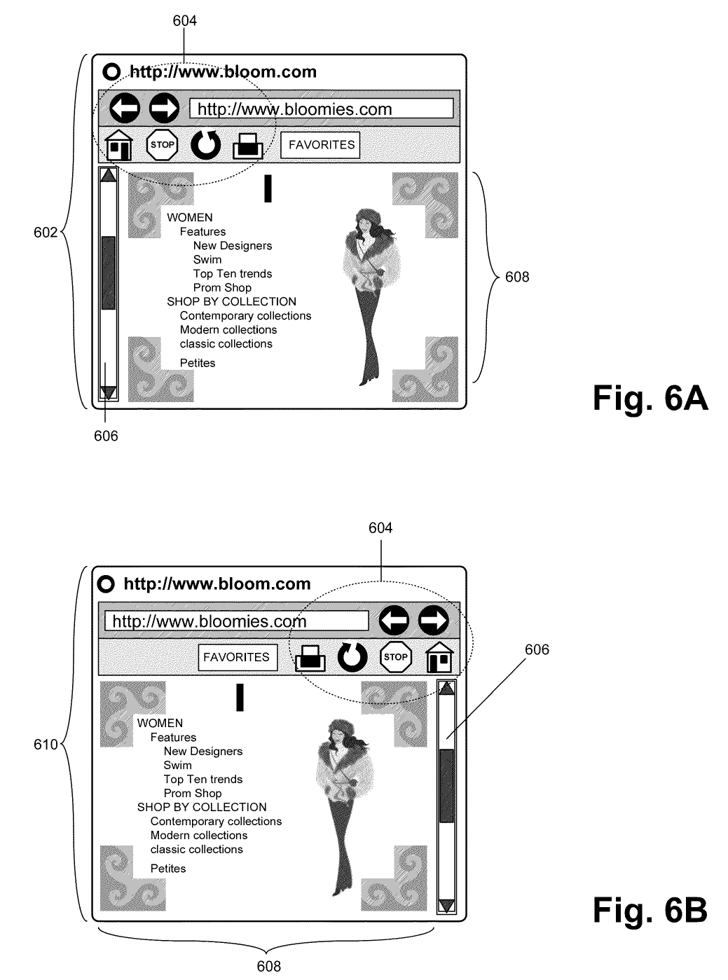

FIGS. 6A and 6B illustrate exemplary GUI components for receiving input from a left hand and a right hand, respectively. More specifically, FIG. 6A shows a left-hand browser window 602. Device 200 may display left-hand browser window 602 when hand recognition logic 506 detects and identifies a finger that belongs to a left hand. As shown, left-hand browser window 602 may include buttons 604 and a scroll bar 606 that are placed on browser window 602 to allow different browser functionalities to be accessed with the left hand without interfering with a user's view of viewing pane 608.

FIG. 6B shows a right-hand browser window 610. Device 200 may display right-hand browser window 610 when hand recognition logic 506 detects and identifies a finger that belongs to a right hand. As shown, right-hand browser window 610 may include buttons 604 and a scroll bar 608 that are placed on browser window 610 to allow different browser functionalities with the right hand to be accessed without interfering with a user's view of viewing pane 608.

### Exemplary Processes for Finger Recognition/Identification

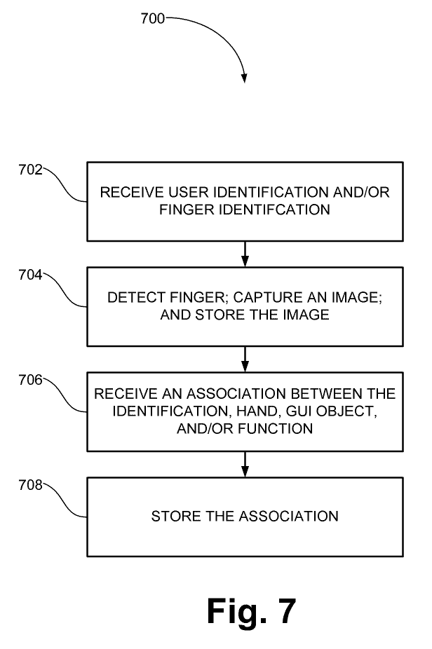

FIG. 7 is a flow diagram of an exemplary process 700 associated with hand registration. Registration process 700 may result in storing a finger image in a database that may be searched to identify a matching image and a corresponding hand that the finger belongs to.

Assume that hand recognition logic 506 is displaying a GUI for hand registration. Process 700 may start with hand recognition logic 506 receiving user identification information (e.g., a user name, address, etc.), hand identification information, and/or finger identification information (block 702). For instance, a user may input personal information (e.g., contact information, user id, etc.) into text boxes. In another example, the user may place a check in a checkbox that is associated with a specific finger (e.g., a checkbox next to “left index finger”) and/or a hand (e.g., a left hand or right hand).

Device 200 may detect a finger, capture an image of the finger, and store the image (block 704). For example, when a left index finger moves toward display screen 400, device 200 may detect the finger. In addition, via scanning panel 406, device 200 may capture an image of the finger. Once the image is captured, device 200 may store the image and the identification information in a database (block 704). Given a matching image, device 200 may retrieve the identification information from the database.

Device 200 may receive an association between the identification information (e.g., finger identification, user identification, and/or hand identification), a GUI object (or another type of object), and/or a function (block 706). For example, via a GUI, the user may select a right or left hand and GUI component with which the user wishes the recognized hand or finger to be associated. The GUI component may be presented to the user when the finger touches display screen 400. For example, when the user touches display screen with the left hand, device 200 may present left-hand browser 602. In some implementations, device 200 may provide default associations that do not require user input.

Device 200 may store the association between the identification information (e.g., a right hand or left hand, etc.), the GUI object (or type of GUI object), and/or the function (block 708). The stored information may later be searched based on the identification information.

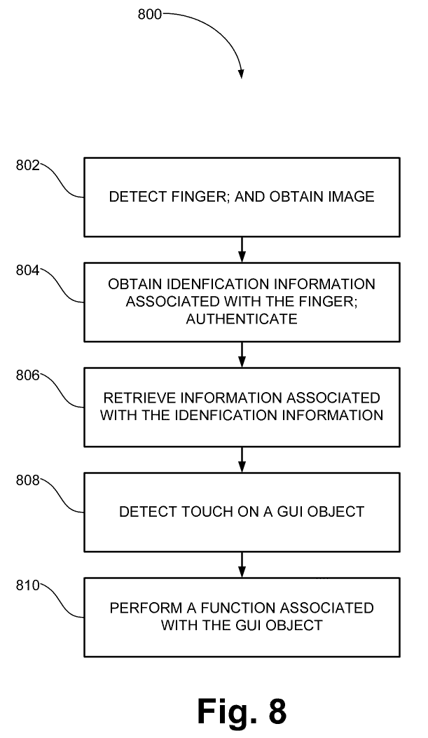

FIG. 8 is a flow diagram of an exemplary process 800 for identifying/recognizing a hand. Assume that hand recognition logic 506 is displaying a GUI for a specific task. Process 800 may start with device 200 detecting a finger that is proximate to a surface of its display screen (block 802). For example, device 200 may detect a left index finger that is close to or touching the surface of display screen 400.

Device 200 may obtain an image of the finger (block 802). For example, when device 200 detects a left index finger, device 200 may obtain a fingerprint or an image of veins of the left index finger.

Device 200 may obtain identification information associated with the finger (block 804). To obtain the identification information, device 200 may search a database of finger images and associated identification information (see blocks 702 and 704). The identification information may indicate which hand the finger belongs to. In some implementations, device 200 may also authenticate the user based on the identification information (block 804). Depending on the result of the authentication, device 200 may allow or prevent the user from accessing specific functions and/or from further using device 200.

Device 200 may retrieve information associated with the identification information (block 806). Using the identification information, device 200 may search associations that are stored in device 200 (see block 706). More specifically, using the identification information as a key, device 200 may retrieve functions and/or GUI objects (e.g., right-hand browser 610) that are associated with the identification information.

In addition, depending on the implementation, device 200 may perform actions that pertain to the retrieved GUI objects. For instance, in one implementation, GUI components of a browser may be arranged to accommodate a right-hand or left-hand access (e.g., place a scroll bar on the right wide of a browser window).

Device 200 may detect user's touch on one of GUI objects that are associated with the identification information (block 808). Continuing with the preceding example, when the user touches a GUI object on the browser, device 200 may detect the touch and identify the touched GUI object.

Device 200 may perform a function associated with the GUI object based on the identified finger/hand (block 810). For example, assume that left hand browser 602 is associated with the left hand and “sending an email to John” function is associated with the user's left index finger and with the selected GUI object. Upon detecting the touch on the GUI object, device 200 may prepare a new email message to be sent to John, with the body of the new email message to be provided by the user.

In process 800, GUI objects may be retrieved based on the hand or finger's identification. In a different implementation, device 200 may identify a GUI object that is touched by a finger. Once the touched GUI object is determined, device 200 may obtain the identification information for the finger/hand and use the identification information to determine what function may be performed when the specific hand touches the GUI object. Note that, depending on which hand touches the GUI object, a different function may be performed.

### EXAMPLE

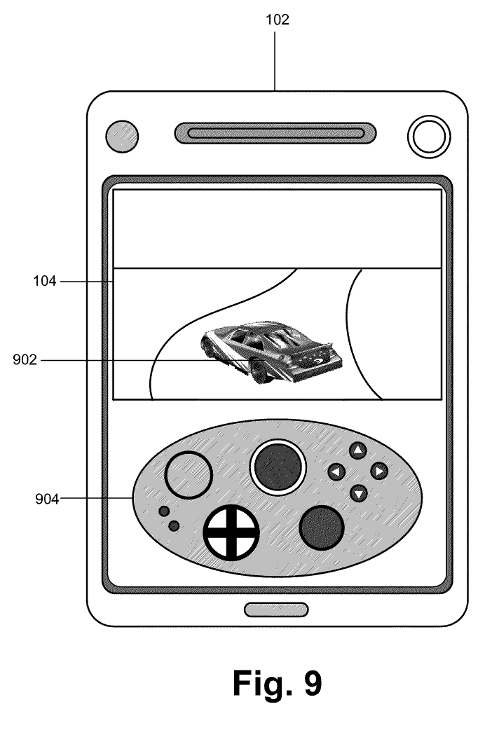

FIG. 9 illustrates an example associated with identifying/recognizing a hand. The example is consistent with exemplary processes 700 and 800 described above with reference to FIGS. 7 and 8. FIG. 9 shows device 102. Assume that Mr. Takamoto's hands and/or fingers are registered at device 102.

Mr. Takamoto decides to play a video game that is installed on device 102. Assume that the game involves driving an automobile 902. When Mr. Takamoto touches display 104 with a right index finger, device 102 obtains an image of veins of Mr. Takamoto's right index finger, and retrieves information that identifies Mr. Takamoto's right hand.

Based on the identification, device 102 displays control buttons 904. Via control buttons 904, device 102 receives user input for controlling automobile 902. For example, by manipulating individual buttons on control buttons 904, Mr. Takamoto may steer, brake, or accelerate automobile 902. The individual buttons on control buttons 904 may be arranged or configured to allow Mr. Takamoto to more easily control automobile 902 with his right hand than with his left hand.

In some implementations, when Mr. Takamoto touches display 104, device 102 may authenticate Mr. Takamoto, and allow Mr. Takamoto to access specific functionalities of device 102 (e.g., game).

### Conclusion

The foregoing description of implementations provides illustration, but is not intended to be exhaustive or to limit the implementations to the precise form disclosed. Modifications and variations are possible in light of the above teachings or may be acquired from practice of the teachings.

For example, while series of blocks have been described with regard to the exemplary processes illustrated in FIGS. 7 and 8, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A device comprising:
a first sensor for detecting a finger, and
a second sensor for capturing an image of the finger; and
a processor to:
obtain an image from the second sensor when the first sensor detects a finger,
determine whether the detected finger belongs to a right hand or a left hand based on the image,
perform a function associated with the right hand when the detected finger belongs to the right hand, and
perform a function associated with the left hand when the detected finger belongs to the left hand.

2. The device of claim 1, wherein when the processor performs a function associated with the right hand, the processor is further configured to:
arrange graphical user interface (GUI) components for the right hand.

3. The device of claim 3, wherein the graphical user interface (GUI) components include at least one of:
a button; a menu item; an icon; a cursor; an arrow; a text box; a scroll bar; an image; text; or a hyperlink.

4. The device of claim 1, wherein the processor is further configured to:
register the right hand and the left hand.

5. The device of claim 4, wherein the processor to register the right hand is further configured to:
associate a registration image of the finger with the right hand.

6. The device of claim 1, wherein the device includes;
a mobile phone, an electronic notepad, a gaming console, a laptop computer, a personal digital assistant, or a personal computer.

7. The device of claim 1, wherein the first sensor includes a touch screen; and the second sensor includes one of:
a scanner; a charge coupled device; an infrared sensor; or an acoustic sensor.

8. The device of claim 1, wherein the image includes at least one of:
image of veins of the finger, a fingerprint, or finger shape.

9. The device of claim 1, wherein the second sensor is located in an action button area included within the display.

10. The device of claim 1, wherein the function includes at least one of:
browsing a web page; placing a call; sending an email to a particular address; sending multimedia message; sending an instant message; viewing or editing a document; playing music or video; scheduling an event; or modifying an address book.

11. A method comprising:
detecting a finger when the finger is close to or touching a display of a device;
obtaining an image of the finger when the finger is detected;
determining whether the finger belongs to a right hand or a left hand based on the image;
providing a left-hand graphical user interface when the finger belongs to the left hand; and
providing a right-hand graphical user interface when the finger belongs to the right hand.

12. The method of claim 11, wherein responding to user input includes one or more of:
loading a web page; placing a call to a particular user; opening an email application to compose an email to be sent to a particular address; sending a multimedia message to a user; sending an instant message to one or more users; loading a document for editing; playing music or video; scheduling an appointment; or inserting or deleting an entry from an address book.

13. The method of claim 11, further comprising:
registering the right hand and the left hand.

14. The method of claim 13, wherein registering the right hand includes:
capturing a registration image of the finger;
creating an association between the registration image and the right hand; and
storing the association between the registration image and the right hand.

15. The method of claim 11, further comprising:
authenticating a user based on the image.

16. The method of claim 11, wherein obtaining the image of the finger includes:
obtaining an image of veins of the finger;
obtaining a fingerprint; or
obtaining a shape of the finger.

17. The method of claim 11, wherein obtaining an image includes:
obtaining the image based on at least one of: reflected light from the finger, a reflected infrared signal, or a reflected acoustic signal.

18. A computer-readable medium including computer-executable instructions, the computer-executable instructions including instructions for:
obtaining an image of a finger from a sensor when a device detects a touch;
retrieving identification information by looking up the identification information in a database based on the image;
identifying a hand to which the finger belongs based on the identification information; and
displaying a graphical user interface that is associated with the identified hand.

19. The computer-readable medium of claim 18, wherein the device includes one of: a cell phone, an electronic notepad, a gaming console, a laptop computer, a personal digital assistant, or a personal computer.

20. The computer-readable medium of claim 18, further comprising instructions for associating a registration image of the finger with the identified hand.
